(19) United States
(12) Patent Application Publication
(10) Pub. No.: US 2007/0286529 A1
(43) Pub. Date: Dec. 13, 2007

(54) Table value conversion device and method for converting and writing table value

(75) Inventor: Yuji Watarai, Kasugai (JP)

Correspondence Address: ARENT FOX LLP, 1050 CONNECTICUT AVENUE, N.W., SUITE 400, WASHINGTON, DC, 20036, US

(73) Assignee: FUJITSU LIMITED

(21) Appl. No.: 11/715,315

(22) Filed: Mar. 8, 2007

(30) Foreign Application Priority Data
Mar. 29, 2006 (JP) 2006-091274

(51) Int. Cl. G06K 9/54

(52) U.S. Cl. 382/305

(57) ABSTRACT

A table value conversion device for use with a memory storing a default table value, a central processing unit for reading a default table value from the memory and outputting an output value, and a functional macro functioning as hardware for processing data and storing a lookup table. The device enables simple and efficient rewriting of values stored in the memory. The device includes a conversion module arranged on an external bus extending between the memory and the central processing unit. The conversion module receives the output value of the central processing unit, performs a correction computation on the received output value to generate a corrected value, and converts a table value of the lookup table in the functional macro based on the corrected value.

### CROSS-REFERENCE TO RELATED APPLICATIONS

This application is based upon and claims the benefit of priority from prior Japanese Patent Application No. 2006-091274, filed on Mar. 29, 2006, the entire contents of which are incorporated herein by reference.

### BACKGROUND OF THE INVENTION

The present invention relates to improvements in a device and method for converting values in a table memory stored as a lookup table.

Electronic devices, such as an electronic camera, a digital copying machine, and a laser printer, normally include an image processor for converting digital image data. A typical image processor has a table memory that uses a lookup table (LUT). The lookup table of the table memory may store table values, such as color correction values. The image processor converts image data based on a table value stored in the lookup table of the table memory and performs color correction on the data to generate corrected image data. More specifically, the image processor accesses the table memory at an address of the original image data, reads a table value corresponding to that address from the table memory, and performs color correction on the original image data in accordance with the read table value.

In an image processor of the prior art performing color correction with the LUT table memory, table values stored in the table memory may have to be rewritten when performing image characteristics correction, such as gamma correction, contrast correction, and chroma correction. Methods for rewriting the table memory in the prior art will now be described with reference to FIGS. 1(a), 1(b), and 1(c).

In the case of a first prior art method shown in FIG. 1(a), a ROM 60 includes a plurality of table memories TM respectively corresponding to various image characteristics. For example, to enhance contrast, a CPU 61 reads data from the table memory TM of the ROM 60 that corresponds to the contrast characteristic. The CPU 61 then rewrites the data of an LUT 63 for a macro 62 based on values of the read table memory TM (Japanese Laid-Open Patent Publication No. 6-70165).

In the case of a second prior art method shown in FIG. 1(b), a ROM 60 includes a reference table memory STM. A CPU 64 reads table values from the reference table memory STM, corrects the table values, and rewrites an LUT 63 for a macro 62 based on the corrected table values (Japanese Laid-Open Patent Publication No. 6-133158).

In the case of a third prior art method shown in FIG. 1(c), a computer 65, which is for use exclusively with a macro 62 of an LUT 63, performs predetermined computation with image data output via the LUT 63 to enable required processing of the obtained image data such as correction and enhancement.

### SUMMARY OF THE INVENTION

With these prior art methods, the table values stored in the LUT table memory are rewritten or computed to ensure that various corrections or the like of the obtained image data are performed. However, in practice, these methods all have problems that cannot be ignored and therefore must be improved.

For example, the first method described in FIG. 1(a) normally requires a plurality of the table memories TM to be prepared in the ROM 60, which is used as a program memory. This increases the memory capacity of the ROM 60. The second method described in FIG. 1(b) requires the CPU 64 to perform a correction computation. This increases the computation load of the CPU 64 and consequently increases the entire processing time required for image processing. The third method shown in FIG. 1(c) requires an exclusive computer for each macro. This requires more computers for more macros, and inevitably increases the production cost of the image processor.

The present invention is directed to simple and efficient rewriting of values stored in a table memory that uses a lookup table.

One aspect of the present invention is a table value conversion device for use with a memory storing a default table value, a central processing unit for reading the default table value from the memory and outputting an output value, and a functional macro functioning as hardware for processing data and storing a lookup table. The table value conversion device has an external bus including a conversion module arranged thereon. The external bus extends between the memory and the central processing unit. The conversion module receives the output value of the central processing unit, performs a correction computation on the received output value to generate a corrected value, and converts a table value of the lookup table in the functional macro based on the corrected value.

A further aspect of the present invention is a method for converting and writing a table value. The method includes arranging a conversion module on an external bus extending between a memory, which stores a default table value, and a central processing unit, which reads the default table value from the memory and outputs an output value; receiving the output value of the central processing unit and performing a correction computation on the received output value to generate a corrected value with the conversion module; and writing the corrected value of the conversion module to a lookup table in a functional macro functioning as hardware for processing data when rewriting a table value of the lookup table.

### BRIEF DESCRIPTION OF THE DRAWINGS

The invention, together with objects and advantages thereof, may best be understood by reference to the following description of the presently preferred embodiments together with the accompanying drawings in which:

FIGS. 1(a), 1(b), and 1(c) are block diagrams of table value conversion devices in the prior art;

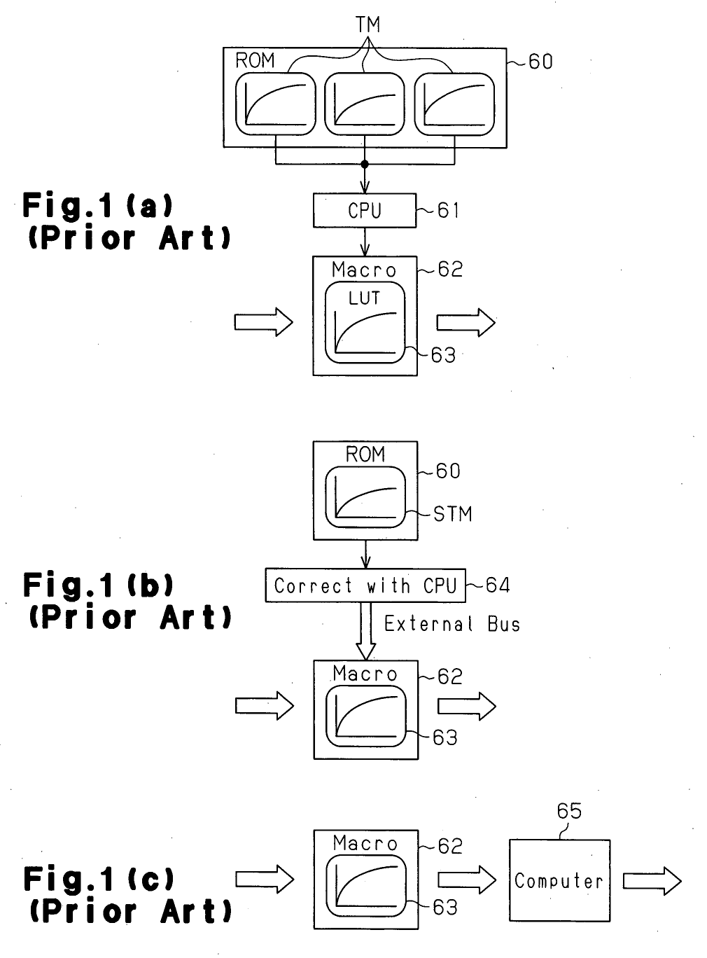

FIG. 2 is a block diagram of a table value conversion device according to a preferred embodiment of the present invention;

FIG. 3 is a block diagram of a conversion module in the table value conversion device of FIG. 2; and

FIG. 4 is a flowchart showing the procedures for converting and writing table values in the preferred embodiment.

### DETAILED DESCRIPTION OF THE PREFERRED EMBODIMENTS

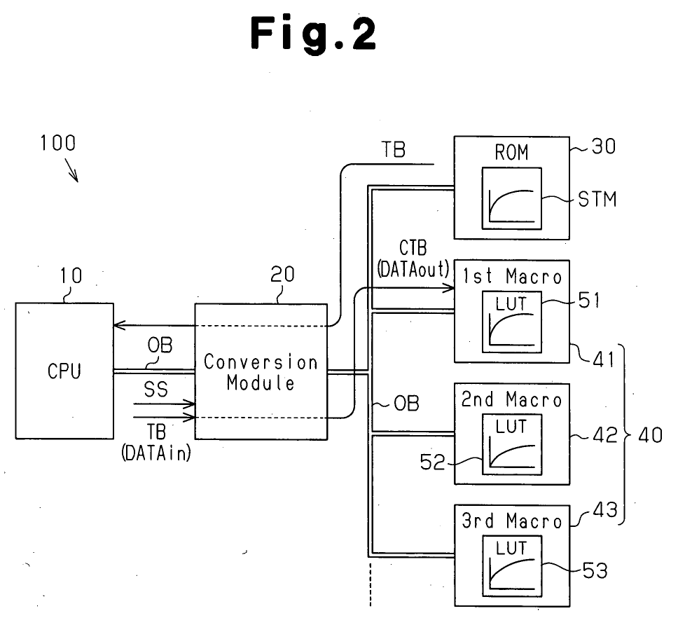

A table value conversion device and a method for converting and rewriting a table value according to a preferred embodiment of the present invention will now be described with reference to FIGS. 2 to 4.

As shown in FIG. 2, a table value conversion device 100 of the preferred embodiment includes a central processing unit (CPU) 10, a conversion module 20 arranged along an external bus OB of the CPU 10, and a ROM 30 and macros 40 that are commonly connected to the external bus OB.

The CPU 10 centrally controls processing relating to image processing. For example, based on digital image data or the like obtained by, for example, an image acquisition device, the CPU 10 provides the macros 40 (to be accurate, a single macro designated by the CPU 10) with a conversion command for converting the data or with a table value conversion and writing command.

The macros 40 are hardware for performing data processing such as image processing. In the preferred embodiment, the macros 40 may be formed by a first macro 41, a second macro 42, and a third macro 43. The macros 41 to 43 respectively include LUTs 51, 52, and 53. The LUTs 51, 52, and 53 differ from one another in their characteristics. When provided with a conversion command and data (value) from the CPU 10, each of the macros 41 to 43 converts the provided data by referring to the corresponding LUT.

The conversion module 20 is arranged along the external bus OB between the macros 41 to 43 and the CPU 10. The conversion module 20 has computation functions such as multiplication, addition, and clipping. When converting and writing table values of the LUTs 51 to 53, the conversion module 20 aids the processing performed by the CPU 10. More specifically, when converting and writing a table value, the CPU 10 reads a default table value used for rewriting an LUT, that is, a table value TB from a reference table memory STM of the ROM 30 that is commonly connected to the external bus OB. The CPU 10 then provides the conversion module 20 with the read table value TB via the external bus OB. Before reading the table value, the CPU 10 provides the conversion module 20 with a setting signal SS, and sets or registers conversion parameters used for correction computation of the table value TB in the conversion module 20. Examples of the conversion parameters include a multiplication coefficient (multiplication value) M, an addition constant (addition value) A, an upper limit clip value H, and a lower limit clip value L. Based on the registered conversion parameters, the conversion module 20 performs a computation to correct the table value TB and generate a corrected table value CTB. The conversion module 20 then provides the macro designated by the CPU 10 with the corrected table value CTB. This updates or rewrites the LUT of the designated macro with the corrected table value CTB.

As described above, in the preferred embodiment, the conversion module 20 arranged on the external bus OB of the CPU 10 substantially converts the table value. The CPU 10 simply reads the default table value TB from the reference table memory STM of the ROM 30 and outputs the default table value TB to the external bus OB. The output table value TB is converted by the correction computation of the conversion module 20. Then, the converted value resulting is written to the LUT of the designated macro.

In the preferred embodiment, when the CPU 10 reads the table value TB from the ROM 30, the conversion module 20 transfers the table value TB read from the ROM 30 to the CPU 10 without converting the table value TB. When the LUT for the macro 40 is referenced and normal data conversion (image processing) is performed, the conversion module 20 does not perform the conversion operation. That is, the processing of the conversion module 20 is skipped.

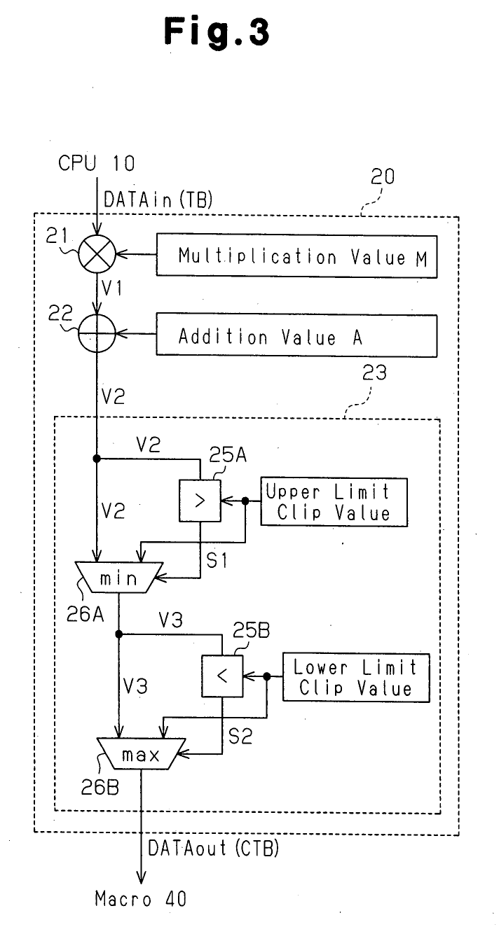

A correction computation circuit of the conversion module 20 that converts table values and the correction computation performed by the correction computation circuit will now be described with reference to FIG. 3.

In the conversion module 20, the correction computation circuit includes a multiplier 21, an adder 22, and a clip circuit 23. The conversion module 20 receives a setting signal SS from the CPU 10. The multiplier 21 receives a multiplication coefficient M, which is a conversion parameter registered in a register or the like based on the setting signal SS. The conversion module 20 receives a table value TB output from the CPU 10 as input data DATAin. The multiplier 21 multiplies the input data DATAin by the multiplication coefficient M and outputs a computation value V1, resulting from the multiplication, to the adder 22. The adder 22 receives an addition constant A, which is a conversion parameter registered in a register or the like based on the setting signal SS. The adder 22 adds the addition constant A to the computation value V1 and provides a computation value V2, resulting from the addition, to the clip circuit 23.

The clip circuit 23 includes a first comparator 25A, a second comparator 25B, a first selection circuit 26A, and a second selection circuit 26B. The computation value V2 of the adder 22 is provided to both the first comparator 25A and the first selection circuit 26A. The first comparator 25A is provided with the computation value V2 input from the adder 22 as well as an upper limit clip value H, which is a conversion parameter set in a register or the like based on the setting signal SS. The first comparator 25A compares the computation value V2 with the upper limit clip value H to provide the first selection circuit 26A with a comparison result signal S1 indicating whether the computation value V2 is greater than the upper limit clip value H. The first selection circuit 26A is also provided with the computation value V2 and the upper limit clip value H in the same manner as the first comparator 25A. The first selection circuit 26A selects the smaller one of the computation value V2 and the upper limit clip value H based on the comparison result signal S1 received from the first comparator 25A to output the selected value. For example, when the computation value V2 is smaller than the upper limit clip value H, the first selection circuit 26A selectively outputs the computation value V2 as an output value V3. When the upper limit clip value H is smaller than the computation value V2, the first selection circuit 26A selectively outputs the upper limit clip value H as the output value V3. The output value V3 of the first selection circuit 26A is provided to both the second comparator 25B and the second selection circuit 26B. The second comparator 25B is provided with the output value V3 as well as a lower limit clip value L, which is a conversion parameter set in a register or the like based on the setting signal SS. The second comparator 25B compares the output value V3 of the first selection circuit 26A with the lower limit clip value L to provide the second selection circuit 26B with a comparison result signal S2 indicating whether the output value V3 is smaller than the lower limit clip value L. The second selection circuit 26B is also provided with the output value V3 of the first selection circuit 26A and the lower limit clip value L in the same manner as the second comparator 25B. The second selection circuit 26B selects a greater one of the output value V3 and the lower limit clip value L based on the comparison result signal S2 received from the second comparator 25B to output the selected value. For example, when the output value V3 of the first selection circuit 26A is greater than the lower limit clip value L, the second selection circuit 26B selectively outputs the output value V3 as output data DATAout. When the lower limit clip value L is greater than the output value V3, the second selection circuit 26B selectively outputs the lower limit clip value L as the output data DATAout. The conversion module 20 provides the output data DATAout to the macros 40.

As described above, the conversion module 20 generates the output data DATAout by subjecting the table value TB of the reference table memory STM input from the CPU 10, that is, the input DATAin, to the next correction computation.

DATAout=max(L, min(H, DATAin*M+A)).

In the above equation, max(a,b) is a function for selecting the greater one of values a and b, and min(a,b) is a function for selecting the smaller one of values a and b.

The employment of the conversion module 20 enables table value conversion with a relatively high degree of freedom using parameters including the multiplication coefficient M and the addition constant A. Further, the combined employment of the upper limit clip value H and the lower limit clip value L enables conversion of the input data DATAin while suppressing the occurrence of table values greatly deviating from a predetermined range, such as noise elements. When the default table value TB of the reference memory table STM is directly written to the LUT of a macro 40 without being converted, the CPU 10 sets the conversion module 20 in a manner that the table value TB is directly provided to the macros 40 without being converted.

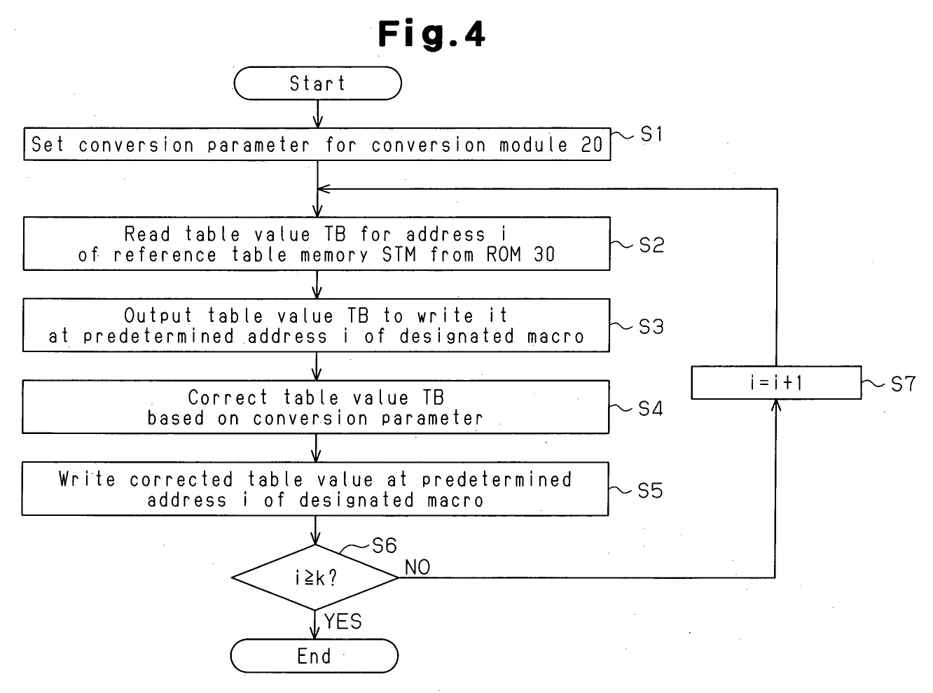

The table value conversion and writing method using the table value conversion device 100 will now be described with reference to FIG. 4. An example in which a table value is converted and written to the LUT 51 of the first macro 41 among the macros 41 to 43 will be described.

When converting a table value and writing the table value to the first macro 41, in step S1, the CPU 10 provides the conversion module 20 with the setting signal SS. Further, the CPU 10 sets conversion parameters corresponding to the LUT 51 of the first macro 41 for the conversion module 20. That is, the CPU 10 sets the multiplication coefficient M, the addition constant A, the upper limit clip value H, and the lower limit clip value L. The CPU 10 may generate a setting signal SS in accordance with conversion parameters input by, for example, a user. The CPU 10 provides the conversion module 20 with this setting signal SS to set the conversion parameters. Alternatively, the CPU 10 may automatically determine conversion parameters suitable for the present imaging environment or the like. In this case, the CPU 10 generates a setting signal SS in accordance with the determined conversion parameters, and provides the conversion module 20 with this setting signal SS.

In step S2, the CPU 10 reads a table value TB for one address, that is, from address i of the reference table memory STM in the ROM 30. When, for example, the reference table memory STM of the ROM 30 has table values TB corresponding to addresses 0 to 25, the table values TB are sequentially read from address 0 one after another.

In step S3, after reading the table value TB for one address in the manner described above, the CPU 10 outputs the read table value TB to the external bus OB to write the read table value TB at the same address i of the first macro 41. More specifically, when the table value TB is read from address 0 of the ROM 30 in step S2, the CPU 10 outputs the read table value TB to rewrite the table value at address 0 of the LUT 51 in the first macro 41.

In step S4, the conversion module 20 performs a computation to correct the table value TB output from the CPU 10 based on the conversion parameters set in step S1. More specifically, the conversion module 20 performs the correction computation described above using the table value TB output from the CPU 10 as the input data DATAin and the corrected table value CTB as the output data DATAout.

In step S5, after correcting the table value TB, the conversion module 20 outputs the output data DATAout, that is, the corrected table value CTB, to the first macro 41. More specifically, the conversion module 20 writes the corrected table value CTB at the predetermined address i of the LUT 51 in the first macro 41 in accordance with the writing command provided from the CPU 10 in step S3. This rewrites the table value at address i of the LUT 51 in the first macro 41 with the corrected table value CTB.

Subsequently, in step S6, the value of address i, which is the address at which the table value is read from the ROM 30 as well as the address at which the table value is written to the LUT 51 in the macro 41, is compared with a total address number k of the reference table memory STM in the ROM 30 and the LUT 51 in the first macro 41. When the value of address i is less than the total address number k, the CPU 10 increments the value of address i in step S7, and returns to step S2. The processing in steps S2 to S7 is repeated until the value of address i reaches the total address number k, that is, until the table values at all the addresses are completely rewritten. When the value of address i reaches the total address number k in step S6, the table value conversion and writing to the LUT 51 of the first macro 41 is terminated. The processing described above ensures that the table values of the LUT 51 in the first macro 41 are each converted.

The preferred embodiment has the advantages described below.

(1) The conversion module 20 connected between the CPU 10 and the macros 40, that is, arranged on the external bus OB, performs a correction computation on the reference table values TB and writes the corrected table values CTB to the LUT of each macro 40. This enables the single conversion module 20 to convert the table values TB for the LUTs of a plurality of macros and write the corrected table values CTB to the LUTs of the plurality of macros. This reduces the production cost of the image processor and minimizes the capacity of the reference table memory STM stored in the ROM 30. Thus, an increase in the memory capacity is suppressed. Further, the employment of the conversion module 20 significantly reduces the computation load on the CPU 10 and consequently shortens the processing time of the CPU 10. More specifically, the conversion and writing of table values for the LUTs in each macro is efficiently performed with a simple structure.

(2) Based on conversion parameters set by the CPU 10, that is, the multiplication coefficient M, the addition constant A, the upper limit clip value H, and the lower limit clip value L, the conversion module 20 converts the input data DATAin (table value TB) from the CPU 10 to the data DATAout (table value CTB) by performing the correction computation with the next equation.

DATAout=max(L, min(H, DATAin*M+A))

This enables table value conversion with a high degree of freedom using parameters including the multiplication coefficient M and the addition constant A. Further, the combined use of the upper limit clip value H and the lower limit clip value L suppresses the occurrence of table values greatly deviating from a predetermined range, such as noise elements.

(3) The ROM 30 and the macros 41 to 43 are commonly connected to the external bus OB of the CPU 10 via the conversion module 20. This increases the utilization efficiency of the external bus OB. In particular, the ROM 30 is connected to the external bus OB downstream to the conversion module 20. This also increases the design freedom for the entire device.

(4) The conversion module 20 is set so that it does not operate during normal data conversion (image processing) performed using the LUTs 51 to 53. This reduces unnecessary power consumption during normal data conversion (image processing).

The table value conversion and writing method of the preferred embodiment enables the rewriting of table values for lookup tables in any macros.

It should be apparent to those skilled in the art that the present invention may be embodied in many other specific forms without departing from the spirit or scope of the invention. Particularly, it should be understood that the present invention may be embodied in the following forms.

The ROM 30 may be directly connected to the CPU 10.

In the table value conversion and writing method of the preferred embodiment, the table values TB are sequentially read from the addresses of the ROM 30 one after another, and the read table values TB (more accurately, the corrected table values CTB) are sequentially written one after another to the addresses of the LUT in the designated macro, e.g., the LUT 51 in the first macro 41. However, the present invention is not limited to such a method. For example, table values TB within a specific address range may be sequentially read one after another, and the table values TB in the specific address range may be corrected and written to the corresponding addresses of the LUT in the designated macro. When all the table values do not need to be rewritten, that is, when only table values in a certain address range need to be rewritten, this method shortens the time taken for the table value conversion and writing for the LUT.

In the preferred embodiment, the correction computation performed by the conversion module 20 includes multiplication, addition, and clipping of the table value TB output from the CPU 10. However, the present invention is not limited in such a manner. For example the correction computation from which clipping is eliminated may be performed, or the correction computation only including either multiplication or addition may be performed.

The present examples and embodiments are to be considered as illustrative and not restrictive, and the invention is not to be limited to the details given herein, but may be modified within the scope and equivalence of the appended claims.

What is claimed is:

1. A table value conversion device for use with a memory storing a default table value, a central processing unit for reading the default table value from the memory and outputting an output value, and a functional macro functioning as hardware for processing data and storing a lookup table, the table value conversion device comprising:
a conversion module arranged on an external bus extending between the memory and the central processing unit, wherein the conversion module receives the output value of the central processing unit, performs a correction computation on the received output value to generate a corrected value, and converts a table value of the lookup table in the functional macro based on the corrected value.

2. The table value conversion device according to claim 1, wherein the conversion module has a settable conversion parameter and performs the correction computation in accordance with the conversion parameter.

3. The table value conversion device according to claim 2, wherein the conversion parameter of the conversion module includes a multiplication value, an addition value, a lower limit clip value, and an upper limit clip value, and the conversion module performs the correction computation using the equation of:
DATAout=max(L, min(H, DATAin*M+A)),
where M is the multiplication value, A is the addition value, L is the lower limit clip value, H is the upper limit clip value, DATAin is the output value of the central processing unit, DATAout is the corrected value output by the conversion module, max(a,b) is a function for selecting the greater one of values a and b, and min(a,b) is a function for selecting the smaller one of values a and b.

4. The table value conversion device according to claim 1, wherein:
the memory and the functional macro are commonly connected to the external bus of the central processing unit via the conversion module;
when the central processing unit reads the default table value from the memory, the conversion module transfers the default table value passing through the external bus to the central processing unit without converting the default table value; and
when the table value of the lookup table in the functional macro is rewritten, the conversion module performs the correction computation on the output value of the central processing unit passing through the external bus.

5. A method for converting and writing a table value, the method comprising:
arranging a conversion module on an external bus extending between a memory, which stores a default table value, and a central processing unit, which reads the default table value from the memory and outputs an output value;
receiving the output value of the central processing unit and performing a correction computation on the received output value to generate a corrected value with the conversion module; and
writing the corrected value of the conversion module to a lookup table in a functional macro functioning as hardware for processing data when rewriting a table value of the lookup table.

6. The method according to claim 5, further comprising:
setting a conversion parameter for the conversion module used to perform the correction computation; and
determining the corrected value written to the lookup table as a value corresponding to the conversion parameter.

7. The method according to claim 6, wherein
the conversion parameter includes a multiplication value, an addition value, a lower limit clip value, and an upper limit clip value, and the correction computation is performed using the equation of:
DATAout=max(L, min(H, DATAin*M+A)),
where M is the multiplication value, A is the addition value, L is the lower limit clip value, H is the upper limit clip value, DATAin is the output value of the central processing unit, DATAout is the corrected value output by the conversion module, max(a,b) is a function for selecting the greater one of values a and b, and min(a,b) is a function for selecting the smaller one of values a and b.

8. The method according to claim 6, wherein the functional macro is one of a plurality of functional macros, each storing a lookup table, the method further comprising:
setting a conversion parameter for the conversion module, with the conversion parameter corresponding to a lookup table in a designated one of the plurality of functional macros, and then further performing:
(a) reading the default table value for one address from the memory with the central processing unit;
(b) generating an output value written to the lookup table in the designated macro with the central processing unit in accordance with said reading, and generating a corrected value by performing a correction computation on the output value based on the conversion parameter with the conversion module; and
(c) writing the corrected value to a predetermined address of the lookup table in the designated macro, and
wherein an address of the memory from which the table value is read and an address of the lookup table in the designated macro to which the table value is written are incremented while repeating said reading the default table value, said generating an output value, and said writing the corrected value until the conversion of each table value in the lookup table is completed.

9. A digital image processor device, comprising:
a memory storing a default table value;
a central processing unit for reading the default table value from the memory and outputting an output value;
functional macros functioning as hardware for processing data and each storing a lookup table;
an external bus extending between the memory and the central processing unit; and
a conversion module arranged on the external bus, wherein the conversion module receives the output value of the central processing unit, performs a correction computation on the received output value to generate a corrected value, and converts a table value of the lookup table in a single one of the functional macros, which is designated by the central processing unit, based on the corrected value.

10. The digital image processor device according to claim 9, which is an electronic camera, a digital copying machine, or a laser printer.
